(19) United States
(12) Patent Application Publication
(10) Pub. No.: US 2010/0128994 A1
(43) Pub. Date: May 27, 2010

(54) PERSONAL DICTIONARY AND TRANSLATOR DEVICE

(76) Inventor: Jan Scott Zwolinski, Six Mile, SC (US)

Correspondence Address: TURNER PADGET GRAHAM & LANEY, P.A., P.O. BOX 1509, GREENVILLE, SC, 29602, US

(21) Appl. No.: 12/277,140

(22) Filed: Nov. 24, 2008

(51) Int. Cl. G06K 9/72; G06K 7/10; G06F 3/041; G06K 9/22

(52) U.S. Cl. 382/229; 382/321; 382/313; 345/173

(57) ABSTRACT

A handheld dictionary and/or translation device includes an optical scanning element activated by one of an optical switch activated by proximity to text to be scanned, a one-way mechanical switch within the scanning element activated by contact with a printed page, and a mechanical switch separate from the optical element. When activated, the device may be used to scan one or more printed word(s) by wanding the optical element over the word(s). In one aspect, the device includes a display that is activated simultaneously with the optical element. Once the unknown word is scanned, optical character recognition software converts the word to an electronic format, and a controller retrieves the word's definition (or translation) from a corpus within the device for output to the display and/or an audio speaker. The device may be incorporated within a cellular telephone, a personal digital assistant (PDA), a pager, or a handheld computer.

### TECHNICAL FIELD

The present disclosure is directed, in general, to a portable, handheld device for providing definitions and/or translations of optically scanned text. In one configuration, the functionality for optically scanning the text and providing a definition or translation of the text, or a portion thereof, may be incorporated into a cellular telephone, a personal digital assistant, a handheld computer, or the like.

### BACKGROUND

Readers frequently encounter words or phrases in reading material that they may not fully understand. When the reader cannot deduce the word's meaning from context clues, he or she may opt for utilizing either a conventional dictionary, a keypad-type electronic dictionary, or an online dictionary to ascertain the appropriate definition of the troublesome word. However, each of these options has significant drawbacks.

For instance, the conventional dictionary requires a reader to have access to what may be a relatively cumbersome book, which must be manipulated manually to locate the desired word. The keypad-type device requires the reader to type, or key, in the word for which a definition is sought. Readers seeking definitions on a computer must type the web address of an appropriate website or search engine, in addition to the desired word. In these latter cases, the need for additional technology and the sometimes accompanying technical challenges of using this equipment may leave a reader frustrated, particularly in those instances where the reader may be dyslexic or may have physical limitations (such as arthritis, for example) that make typing difficult.

Apart from the aforementioned electronic devices having a keypad, other electronic devices are available, which are configured with optical elements for scanning an unknown word. Exemplary devices, which require a scanning motion of their optics over the desired word(s), are described in International Patent Publication No. W098/03932; and U.S. Pat. Nos. 4,793,812; 4,890,230; 5,062,058; 5,648,760; 5,857,156; and 6,104,845. For instance, U.S. Pat. No. 4,890,230 is a tabletop unit, which has a scanner separate from its processor to scan text of a document. Similarly, U.S. Pat. No. 6,104,845 requires an optical scanning head to scan text, although the housing is in the form of a pen or wand, thus limiting the amount of text that may be readily scanned.

What the industry needs, and currently lacks, is a scanning device that can digitally record a word or text passage in a single wanding action, which is activated by the proximity of the scanning element to the page or by the press of a button. Advantageously, the scanning element and associated functionality may be incorporated within a commonly owned electronic device, such as a cellular telephone, a personal digital assistant, a handheld computer, or the like, thereby eliminating the need for readers to purchase or carry an additional single-function device for defining and/or translating unknown words.

### BRIEF SUMMARY

A handheld dictionary and/or translation device includes an optical scanning element activated by one of an optical switch activated by proximity to text to be scanned, a one-way mechanical switch within the scanning element activated by contact with a printed page, and a mechanical switch separate from the optical element. When activated, the device may be used to scan one or more printed word(s) by wanding the optical element over the word(s). In one aspect, the device includes a display that is activated simultaneously with the optical element. Once the unknown word is scanned, optical character recognition software converts the word to an electronic format, and a controller retrieves the word's definition (or translation) from a corpus within the device for output to the display and/or an audio speaker. The device may be incorporated within a cellular telephone, a personal digital assistant (PDA), a pager, or a handheld computer.

According to a particular aspect of the present disclosure, a portable handheld apparatus for providing a definition or translation of at least one word on a printed page is provided, the apparatus including a hand-holdable housing having an optical system configured to record text; an optical character recognition software disposed in the housing that is in electrical communication with the optical system and that converts the text to a digital output; a display for receiving the digital output of the optical character recognition software; a corpus, or reference, disposed in the housing in electronic communication with the display; and a controller being configured to access a definition or translation of the digital output from the corpus and to direct the definition or translation to the display. The apparatus may be one of a cellular telephone, a personal digital assistant, a pager, and a handheld computer, which has been modified with the inclusion of an optical scanning element and accompanying hardware and software.

In a first aspect, the scanning element may include a one-way mechanical switch, the mechanical switch activating the optical system when the scanning element contacts a printed page and deactivating the optical system when the scanning element is separated from contact with the page.

In another aspect, the optical system may include an optical switch that automatically activates the scanning element when the scanning element is positioned within an, activation height of the page, the activation height being equal to the focal length of the scanning element.

In yet another aspect, the apparatus may include a mechanical switch separate from the scanning element, but in electronic communication with the scanning element, such that the scanning element is activated manually by activation of the switch. Such a configuration may employ a button or switch already present within the apparatus and may be useful for scanning text having a font size larger than the scanning element.

The apparatus may further include an optical system having a contact image sensor; a software program for parsing the recorded text to provide a definition of a word appropriate to the context in which the word is used; a touch screen display; and/or a navigation tool, such as a scroll wheel or a trackball element. Further, the display may be activated simultaneously with the scanning element, so that the user may actively view the text as the text is being scanned.

A method of acquiring a definition or translation of a printed word on a page using a handheld apparatus includes providing a handheld apparatus having an optical system configured to scan text and a display for viewing the scanned text, the optical system further comprising an optical scanning element; loading OCR software in the handheld apparatus, the OCR software being in electronic communication with the optical system; loading reference software, or a corpus, in the handheld apparatus, the reference software being in electronic communication with the OCR software; activating the scanning element and moving the scanning element over the text; directing the scanned text to the OCR software, which converts the scanned text to a digital output, and showing the digital output on the display; accessing a word in the digital output in the reference software; and providing a definition or translation of the accessed word to a user.

In a first aspect, the method may include providing the scanning element with a one-way mechanical switch, the mechanical switch activating the optical system when the scanning element contacts a printed page and deactivating the optical system when the scanning element is separated from contact with the page.

In another aspect, the method may include providing the optical system with an optical switch that automatically activates the scanning element when the scanning element is positioned within an activation height of the page, the activation height being equal to the focal length of the scanning element.

In yet another aspect, the method may include providing the apparatus with a mechanical switch separate from the scanning element, but in electronic communication with the scanning element, such that the scanning element is activated manually by activation of the switch. Such a configuration may employ a button or switch already present within the apparatus and may be useful for scanning text having a font size larger than the scanning element.

The method may also include activating the display simultaneously with the scanning element; providing software to parse the text to provide a contextually relevant definition or translation; providing the optical system with a contact image sensor; providing the display with a touch screen; providing the definition or translation of the word to the user on the display; and/or providing the apparatus with a speaker and providing the definition or translation of the word to the user by the speaker.

Evident from the foregoing introduction, the component parts of the present handheld device are simple and economical to manufacture and use. Other advantages of the disclosure will be apparent from the following description and the attached drawing or can be learned through practice of the present subject matter.

Additional objects and advantages of the present subject matter are set forth in, or will be apparent to, those of ordinary skill in the art from the detailed description herein. Also it should be further appreciated that modifications and variations to the specifically illustrated, referenced, and discussed features and elements hereof may be practiced in various embodiments and uses without departing from the spirit and scope of the subject matter. Variations may include, but are not limited to, substitution of equivalent means, features or steps for those illustrated, referenced or discussed, and the functional, operational, or positional reversal of various parts, features, steps or the like.

Still further, it is to be understood that different embodiments, as well as different presently preferred embodiments, of the present subject matter may include various combinations or configurations of presently disclosed features, steps or elements or their equivalents (including combinations of features, parts, or steps or configurations thereof, not expressly shown in the figures or stated in the detailed description of such figures). Additional embodiments of the present subject matter, not necessarily expressed in the summarized section, may include and incorporate various combinations of aspects of features, components, or steps referenced in the summarized objects above. Those of ordinary skill in the art will better appreciate the features and aspects of such embodiments, and others upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1A is a front plan view of a portable electronic devide in which the present dictionary and translation device is incorporated, according to one aspect of the disclosure;

FIG. 1B is a side perspective view of the portable electronic device of FIG. 1A, showing the optical scanning element of the present dictionary and translation device;

FIG. 2 includes a perspective view and a schematic representation of the device of FIG. 1A, showing the optical scanning element in contact with a page of text, according to one aspect of the disclosure;

FIG. 3 includes a perspective view and a schematic representation of the device of FIG. 1A, showing the optical scanning element in close proximity to a page of text, according to another aspect of the disclosure;

FIG. 4 includes a perspective view and a schematic representation of the device of FIG. 1A, showing the optical scanning element in a position removed from a page of text, according to yet another aspect of the disclosure; and

FIG. 5 is a flow chart showing the operation of the handheld dictionary and translation device of FIG. 1A.

### DETAILED DESCRIPTION

Detailed reference will now be made to the drawings in which examples embodying the present subject matter are shown. The detailed description uses numerical and letter designations to refer to features of the drawings. Like or similar designations of the drawings and description have been used to refer to like or similar parts of various exemplary embodiments.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed description are provided by way of explanation only and are not meant as limitations of the disclosure. The present subject matter thus includes any modifications and variations of the following examples as fall within the scope of the appended claims and their equivalents.

It is to be understood by one of ordinary skill in the art that the following discussion simply describes exemplary embodiments and is not intended as limiting the broader aspects of the present disclosure.

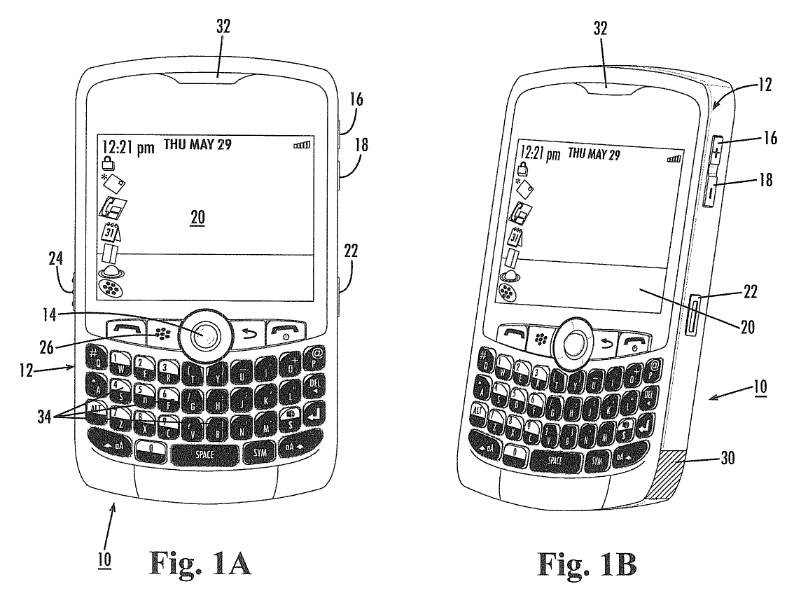

FIGS. 1A through 5 show various aspects of a handheld device or apparatus, designated in general by the element number 10, and its modes of operation. The handheld apparatus 10 may be utilized for scanning printed alphabetic or alphanumeric materials 40, such as are found in a magazine, a book, a paper, or other document, in order to capture, record, define and/or translate text 42 of the materials 40; e.g., an individual word, multiple words or larger sections of text such as paragraphs or whole pages. As will be described in detail below, the handheld apparatus 10 obviates the necessity for typing or key entry of the unknown word(s) 42 by a user, thus simplifying its use. Further, the apparatus 10 is lightweight, compact, readily portable, and user-friendly.

With particular reference to FIGS. 1A and 1B, the handheld apparatus 10 may be a cellular phone, a personal digital assistant, or other similar portable electronic device (such as a BLACKBERRY® brand cell phone, developed by Research In Motion of Waterloo, Ontario, Canada, or an iPHONE® brand cell phone, developed by Apple Inc. of Cupertino, Calif.). Although a particular cellular telephone is used in the illustrations, it should be readily appreciated that other models and types of cellular phones, as well as other types of devices (such as PDAs, pagers, and the like) may be configured with the present scanning elements and its corresponding software and hardware elements.

In general, the apparatus 10 may include a housing 12 configured to be handheld and readily portable. The handheld apparatus 10 may further include a navigation element (such as a “trackball”) 14, a display 20, an optical scanning element 30, right and left programmable convenience buttons 22, 24, a menu button 26, and a keyboard 34. The apparatus 10 may further be equipped with an audio speaker 32 whose volume may be adjusted by a “volume up” button 16 and a “volume down” button 18. The display 20 may include a touch screen, or a separate touch screen may be included on another portion of the apparatus 10. As shown in this example, the optical scanning element 30 may be located conveniently on and/or in the housing 12 to digitally scan the text 42. Those skilled in the art will understand that the scanning element 30 is not limited to the exemplary corner position shown and may be located elsewhere in or on the housing 12, such as on an edge, reverse side, or the like.

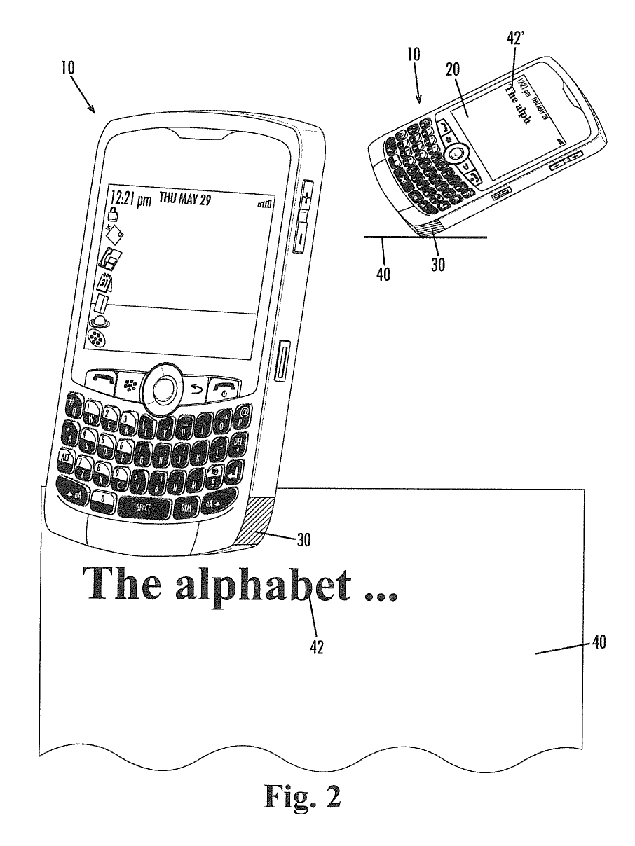

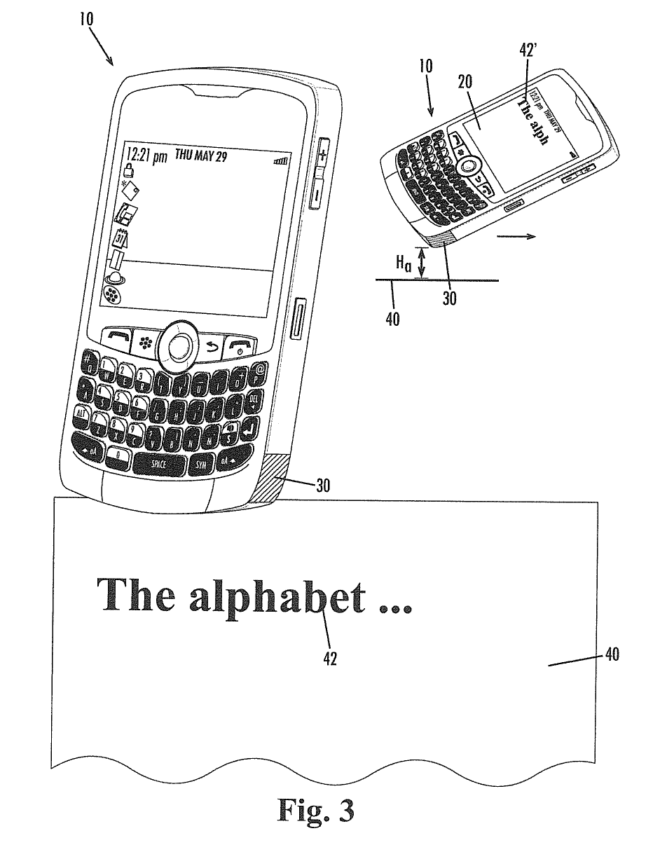

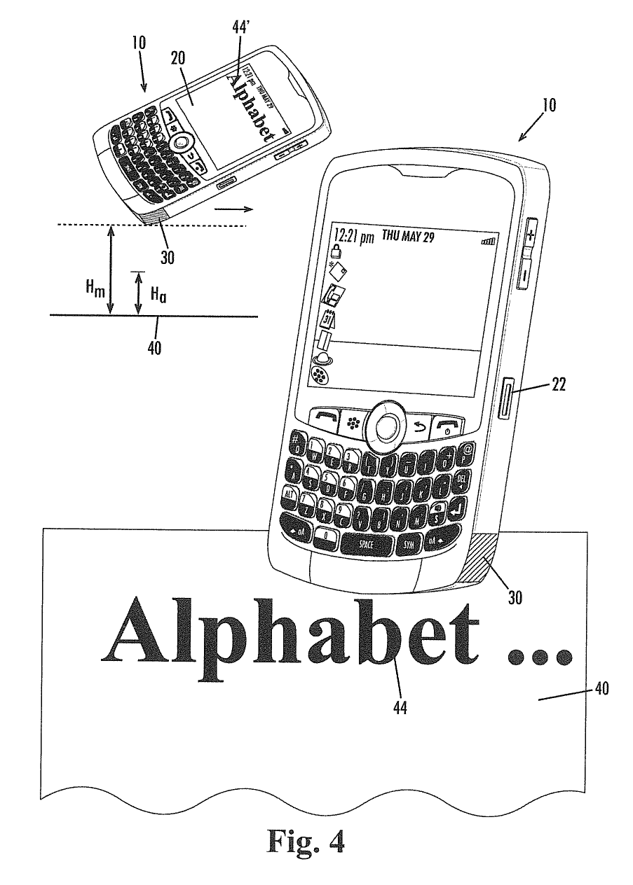

The scanning element 30 may be of the contact image sensor type or some other type of scanning element. The scanning element 30 may be provided with either a one-way mechanical switch or an optical switch, the mechanical switch being activated by contact of the scanning element 30 with the printed page (as shown in FIG. 2) and the optical switch being activated when the scanning element 30 is within a certain proximity of the printed page (as shown in FIG. 3). Alternately, or in addition, the scanning element 30 may be manually activated, for example, by depressing a button or switch that is a component of the device 10 and that is separate from the scanning element 30 (as shown in FIG. 4).

Turning now to FIG. 2, the device 10 may be provided with a one-way mechanical switch within which the optical scanning element 30 is housed. The optical scanning element 30 may be activated, or turned on, by depressing the mechanical switch (that is, pressing the optical scanning element 30) against a surface, such as a printed page 40. Once activated, the scanning element 30 may be wanded, or dragged, over the text 42 to be scanned for definition or translation. In one aspect, the display 20 may be simultaneously activated with the scanning element 30 so that the user may have active visibility of the scanned text 42′ to ensure that the entire word 42 is scanned. The one-way mechanical switch may be deactivated, or turned off, by separating the scanning element 30 from contact with the page 40, thus providing an easy-to-use mechanism for users thereof.

Alternately, the mechanical switch may be replaced with an optical switch, which is activated when the scanning element 30 is positioned in contact with, or proximate to, the printed page 40. The optical switch may be configured with a contact image sensor that has a focal length of from about 1 centimeter to about 2 centimeters. As shown in FIG. 3, the focal length of the optical scanning element 30 defines a distance, or activation height, Hₐ. Accordingly, when the distance between the page 40 and the scanning element 30 is less than or equal to the activation height (Hₐ), the scanning element 30 is activated. Optionally, as described above, the display 20 is also activated, either simultaneously or subsequently.

Because the optical scanning element 30 has a defined size based on the dimensions of the device 10, the size of the text to be scanned is similarly limited. In those circumstances where the font, or print, size of the text 44 is greater than the focal length of the scanning element 30 (i.e., font size>Hₐ), it becomes necessary to raise the device 10 to a higher distance above the page 40 to capture the unknown text 44 (44 being used to indicate large font text). As shown in FIG. 4, the device 10 may be positioned at a second height (Hₘ), greater than the activation height Hₐ of the scanning element 30 and appropriate for the size of the text 44 to be scanned, for scanning the text 44. At this second height, Hₘ, the device 10 may be manually activated by the user, for example, by depressing another button or switch on the device 10. (One example of such a button or switch may be convenience button 22.) Again, as with the previous approaches, the display 20 may be simultaneously (or subsequently) activated with the scanning element 30 so that the user may have active visibility of the scanned text 44′ to ensure that the entire word 44 is scanned.

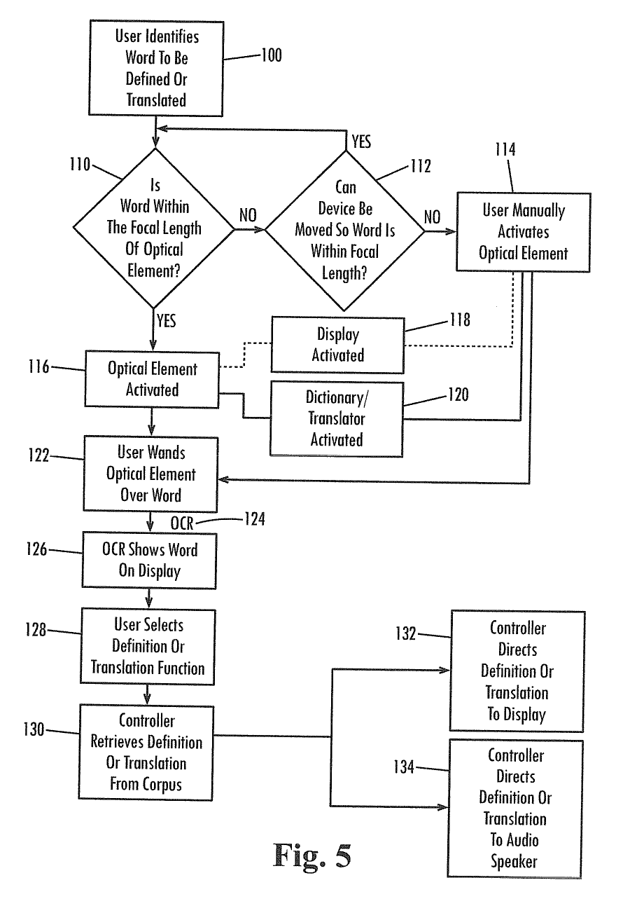

The process employed in the use of the present device 10 may be better understood with reference to FIG. 5. Initially, the user, or reader, identifies a word to be defined or translated (step 100) and decides to use the present device 10 to obtain the definition or translation. The first question that is resolved is whether the printed word (42) is within the focal length of the optical scanning element (30), as shown in step 110. In the event that the word (42) is not immediately positioned within the focal length of the word (42), it may be possible to move the device 10—for example, by moving the device closer to the page (40)—to put the word (42) into range of the optical scanning element (30), as shown in step 112. Once the word (42) is within range of the optical element (30), the optical element (30) may be activated, as shown in step 116, either automatically in the case of an optical switch or manually by contact the mechanical switch component of the optical system with the printed page (40).

Alternately, If the word (44) is printed in a size larger than the optical scanning element (30), it may be difficult to position the device 10 adequately to capture the word (44). In this instance, the user may manually activate the optical scanning element (30) of the device 10, as shown in step 114, for example, by depressing a button or switch programmed for this purpose.

The optical scanning element (30) being activated simultaneously activates the dictionary/translation functionality of the device 10, as shown in step 120. Simply, the dictionary/translation functionality is triggered when the optical scanning element (30) is engaged. Simultaneously, or subsequently, as shown in step 118, the display 20 may also be activated with the optical scanning element (30), such that the user may view an active representation of the text (42, 44) as the text (42, 44) is being scanned.

Having activated the dictionary/translation function and the optical scanning element (30), the user then wands, or drags, the optical scanning element (30) over the unknown word(s) (42, 44), as recited in step 122. As described above with reference to FIGS. 2 through 4, the optical scanning element 30 may be directly in contact with the printed page (40) or may be held a certain distance above the page (40), depending on the font size of the word (42 or 44).

The scanned text (42′ or 44′) is digitally recorded for input to an optical character reader 124, which converts the digitally recorded text (42′, 44′) into an output of alphanumeric characters, such as ASCII (American Standard Code for Information Interchange) characters. By way of example and not of limitation, Experuvisioin of Fremont, Calif. offers OCR software, such as Type Reader®, which might be used for this purpose. Other suppliers having suitable OCR software include, but are not limited to, Nuance Communications of Burlington, Mass. and Readiris of Belgium. The optical character recognition (“OCR”) software that controls the optical character reader 124 directs the output characters to the display 20 of the handheld apparatus 10 for consideration by the user, as shown in step 126.

If more than one word has been scanned, the user may then select portions of the text 42′, 44′ (in OCR format on the display 20) using highlighting or other designation techniques, which may be processed on a word-by-word basis, by virtue of the text 42′, 44′ having been converted from a fixed image into an OCR output.

There are several methods possible for highlighting, or selecting, the specific text 42′, 44′ on the display 20, and the apparatus 10 may include any or all of the tools used to enable these methods. For instance, the user may use a highlight bar to highlight the desired text 42′, 44′. Additionally or alternatively, the navigation element 14 may be used to scroll quickly between words and paragraphs of the text 42′, 44′, and the element 14 or bar may be depressed to highlight a desired word. Still further, the user may select words by moving a cursor on the display 20, for instance, to a particular word or sentence of the text 42′, 44′. As briefly introduced above, the handheld apparatus 10 may be provided with the touch screen and a computer software program to allow the user to highlight an individual word 42′, 44′ on the touch screen, with the program sensing the highlighted word 42′, 44′.

Thus, sentences or portions of sentences may be highlighted, and software that disambiguates sentences may be utilized to understand the context in which the word is used in the sentence, thus providing more accurate definitions or translations. Such contextual reference may be achieved through the use of speech parsing techniques common in speech recognition software. Exemplary parsing software is described in U.S. Pat. No. 5,383,120, which teaches context-specific parsing; and in U.S. Pat. No. 6,697,801, which teaches parsing of words that include non-alphabetic characters (such as hyphens), the disclosures of which are hereby incorporated by reference.

When the unknown word is captured and/or highlighted, the user may then choose whether to receive a definition or a translation of the word 42′, 44′. As indicated in step 128, the selection of the dictionary or translation function may be made by depressing a programmable key or by “selecting” the word 42′, 44′ (for example, by clicking on the word 42′, 44′) to display a drop-down menu. The drop-down menu may include the options “Dictionary” and “Translation”, the “Translation” option being further expandable to show the language(s) loaded as references onto the device 10.

In the present device 10, one or more of such references (such as a dictionary, foreign language dictionary, thesaurus, Grey's Corpus, or the like) are saved in the programmed software to provide a definition or translation of the highlighted text 42′, 44′, the definition or translation being retrieved from the corpus by a controller, as shown in step 130. The highlighted text 42′, 44′ may be shown on the display 20 in juxtaposition to the definition or translation (as shown in step 132) and/or the definition or translation may be announced to the user via a speaker 32 (as shown in step 134).

Evident from the foregoing discussion, the handheld apparatus 10 obviates the necessity for typing or keying the letters of an unknown word 42, 44. Additionally, the dictionary definition or translation of a word in the text 42, 44 can be made to be dependent upon the use of the word or phrase in a sentence, thus providing more accurate definitions or translations, as well as limiting the number of choices that the user might have to review to obtain the appropriate definition or translation. Stated another way, an entire sentence may be recorded so that the parsing software can “understand”, or consider, the context of a highlighted word to provide a more accurate definition or translation.

The apparatus software used to capture, convert, and output the text 42′, 44′ and to retrieve and provide its definition or translation may be pre-loaded onto the apparatus 10 (for example, cell phone or PDA), as an additional feature of the apparatus, before the sale of the apparatus to the user. Another approach is for the user to purchase a memory card containing the application software and to load the software onto an apparatus 10 by inserting the memory card into a corresponding slot in the apparatus 10. Using this approach, the user may add translation capability into one or more different languages by inserting different memory cards. Alternately, the software and additional language references may be added to the apparatus 10 by a wireless connection to a host source, such as an Internet Service Provider or a cellular telephone and wireless internet service provider, or a cable connection to a host source, such as a personal computer. For example, the user may download the software to his personal computer and transfer the software to the apparatus 10 by synchronizing the apparatus 10 and his computer files. By way of yet another example, the user may purchase an additional language reference for his device 10 by ordering and downloading the additional language from a host provider (in much the same way that musical selections are downloaded for a fee).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is provided by way of example rather than by way of limitation, and the subject disclosure does not preclude inclusion of such modifications, variations and/or additions to the present subject matter as would be readily apparent to one of ordinary skill in the art.

That which is claimed is:

1. A portable handheld apparatus for providing a definition or translation of at least one word printed on a page, the apparatus comprising:
a hand-holdable housing;
an optical system held by the housing and comprising an optical scanning element, the optical system being configured to digitally capture text over which the scanning element is wanded, the optical system further being activated by a switch;
optical character recognition software disposed in the housing in electronic communication with the optical system, the optical character recognition software being configured to convert the captured text to a digital output;
a display for receiving the digital output as at least one word;
a corpus disposed in the housing in electronic communication with the display; and
a controller being configured to access a definition or translation of the word in the digital output from the corpus and to direct the definition or translation of the word to the display.

2. The apparatus of claim 1, the scanning element further comprising a one-way mechanical switch, the mechanical switch activating the optical system when the scanning element contacts the page and deactivating the optical system when the scanning element is separated from contact with the page.

3. The apparatus of claim 1, the scanning element further comprising an optical switch, the optical switch being activated automatically when the scanning element is positioned within an activation height of the page, the activation height being equal to the focal length of the scanning element.

4. The apparatus of claim 1, further comprising a mechanical switch separate from the scanning element, the scanning element being activated manually by the mechanical switch when the word has a font size larger than the scanning element.

5. The apparatus of claim 1, wherein the display is activated simultaneously with the scanning element.

6. The apparatus of claim 1, wherein the housing is selected from the group consisting of a cellular telephone, a personal digital assistant, a pager, and a handheld computer.

7. The apparatus of claim 6, wherein the scanning element is located proximate a corner of the housing.

8. The apparatus of claim 1, further comprising a software program for parsing the captured text to provide a definition or translation of the at least one word in the captured text based on text context.

9. The apparatus of claim 1, wherein the optical system comprises a contact image sensor.

10. The apparatus of claim 1, wherein the display includes a touch screen.

11. The apparatus of claim 1, further comprising a navigation element.

12. A method of acquiring a definition or translation of a printed word on a page using a handheld apparatus, the method comprising:
providing a handheld apparatus including an optical system being configured to capture text and a display for viewing text, the optical system comprising an optical scanning element;
loading optical character recognition software in the handheld apparatus, the optical character recognition software being in electronic communication with the optical system;
loading reference software in the handheld apparatus, the reference software being in electronic communication with the optical character recognition software;
activating the scanning element and moving the scanning element over the text;
directing the scanned text to the optical character recognition software, the optical character recognition software converting the scanned text to a digital output, and showing the digital output on the display;
accessing, in the reference software, a word in the digital output; and
providing a definition or translation of the accessed word to a user.

13. The method of claim 12, wherein the handheld apparatus is selected from the group consisting of a cellular telephone, a personal digital assistant, a pager, and a handheld computer.

14. The method of claim 12, further comprising providing the optical system with an optical switch, the activating of the scanning element being accomplished by positioning the apparatus within an activation height of the page to be scanned, the activation height being equal to a focal length of the scanning element.

15. The method of claim 12, further comprising providing the optical system with a one-way mechanical switch coupled with the scanning element, the activating of the scanning element being accomplished by depressing the scanning element against the page to be scanned.

16. The method of claim 15, further comprising deactivating the scanning element by separating the scanning element from contact with the page.

17. The method of claim 12, further comprising providing the apparatus with a mechanical switch separate from the optical system, the mechanical switch being in communication with the optical system, such that activating the scanning element is accomplished by activating the mechanical switch.

18. The method of claim 17, further comprising positioning the scanning element above the page to be scanned at a height higher than a focal length of the scanning element and wanding the scanning element over the text.

19. The method of claim 12, further comprising activating the display simultaneously with the scanning element.

20. The method of claim 12, further comprising providing software to parse the text to provide the definition or translation of the word in the text based on text context.

21. The method of claim 12, further comprising providing the optical system with a contact image sensor.

22. The method of claim 12, further comprising providing the display with a touch screen.

23. The method of claim 12, further comprising providing a definition or translation of the accessed word to the user on the display.

24. The method of claim 12, further comprising equipping the apparatus with a speaker and subsequently providing a definition or translation of the accessed word to the user via the speaker.
